(19) United States
(12) Patent Application Publication
(10) Pub. No.: US 2019/0109965 A1
(43) Pub. Date: Apr. 11, 2019

(54) DEVICE FOR USE IN TAKING PHOTOS

(71) Applicant: JOBAR INTERNATIONAL, INC., Carson, CA (US)

(72) Inventor: Octavio Lopez, San Pedro, CA (US)

(21) Appl. No.: 15/729,553

(22) Filed: Oct. 10, 2017

(51) Int. Cl. H04N 5/225; H04M 1/02; G03B 17/56

(52) U.S. Cl. CPC H04N 5/2252; G03B 17/568; G03B 17/566; H04M 1/0254

(57) ABSTRACT

A mobile phone device includes a body for clamping on to a mobile phone, an arm coupled to the body at or proximate a proximal end of the arm, and a recess extending from the arm at or proximate a distal end of the arm. A method of using such device is also provided.

### BACKGROUND

Taking of selfie or close-up pictures with mobile phones has become very popular. However, it is very often difficult often to have your pet stay still for an appropriate selfie or other photo. Thus, a device that captures your pet's attention for taking a photo or a selfie using a mobile phone is desired.

### SUMMARY

In an example embodiment, a mobile phone device includes a body for connecting with a mobile phone or a camera, an arm coupled to the body at or proximate a proximal end of the arm, and a recess extending from the arm at or proximate a distal end of the arm. In another example embodiment, the arm is lockable to the body at any of multiple orientations relative to the body. In yet another example embodiment, the device also includes a fastener for locking the arm to the body at any of the multiple orientations. In a further example embodiment, the arm includes a first member locked relative to the body at a desired orientation of the multiple orientations relative to the body, a second member separate from the first member, and a spring coupling the first member to the second member. In yet a further example embodiment, the recess extends from the second member. In one example embodiment, the recess is a cup. In a further example embodiment, the device is clamped the mobile phone or camera.

In another example embodiment, a mobile phone device includes a body for clamping on to a mobile phone, an arm including a first member coupled to the body and second member separate from the first member, a spring coupling the first member to the second member, and a receptacle on the second member for holding an item. In yet another example embodiment, the second member flexes relative to the first member. In an example embodiment, the arm is lockable to the body at any of multiple orientations. In a further example embodiment, the device also includes a fastener for locking the arm to the body at any of the multiple the multiple orientations.

In an example embodiment, a method of taking a picture of a pet includes, connecting a mobile phone having a camera or a camera to a device including a flexing arm, holding a treat with the arm for attracting the pet, taking a picture of the pet, flexing the arm, and releasing the flexed arm launching the treat. In another example embodiment, the device includes a body and the arm is connected to the body, and the method also includes orienting the arm to a desired orientation relative to the body, and locking the arm in the desired orientation relative to the body. In yet another example embodiment the body is a grip, and connecting includes gripping the mobile phone having the camera or the camera with the grip. In a further example embodiment, the arm includes a first member coupled to a second member via a spring, and locking the arm includes locking the first member relative to the body. In yet a further example embodiment, the second member includes a recess, and holding the treat includes placing the treat in the recess.

### BRIEF DESCRIPTION OF THE DRAWINGS

FIG.1 is a perspective view of an example embodiment device for use in taking photos.

FIG. 2 is an assembly view of the device shown in FIG. 1.

FIG. 3 is top view of the device shown in FIG. 1 with a mobile phone gripped by the device.

### DETAILED DESCRIPTION

In an example embodiment, a device 10 for allowing a pet owner to take pictures or selfies of a pet is provided. The device includes a body or grip 12 for gripping a mobile phone to be used in taking the picture is provided. Any grip may be used. An example grip is a channel type grip having opposing side members 14, 16. The opposing side members may be spread apart against a spring force that urges the opposing side members to come together so as to clamp or grip a mobile phone. Such exemplary embodiment grips are known. Other grips may also be used as, for example, grips that grip to the front and rear of a phone without blocking the camera, such as the grip described in U.S. Pat. No. 9, 516,203 (the contents of which are fully incorporated herein by reference) using by opposing members 16, 17 disclosed therein.

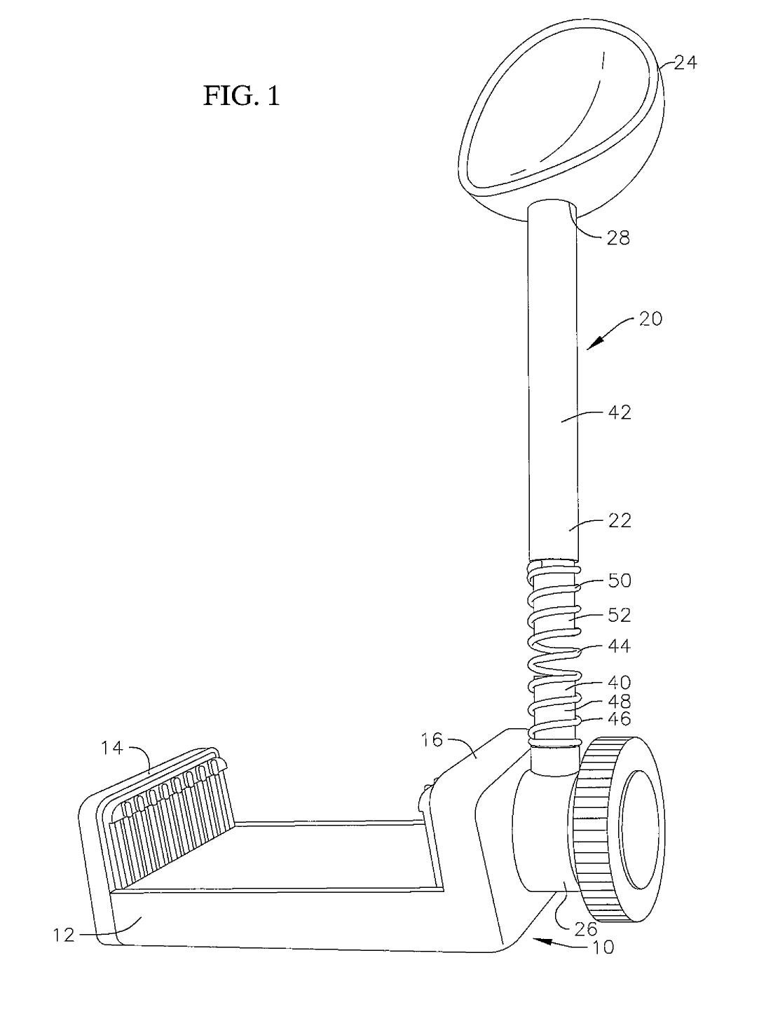

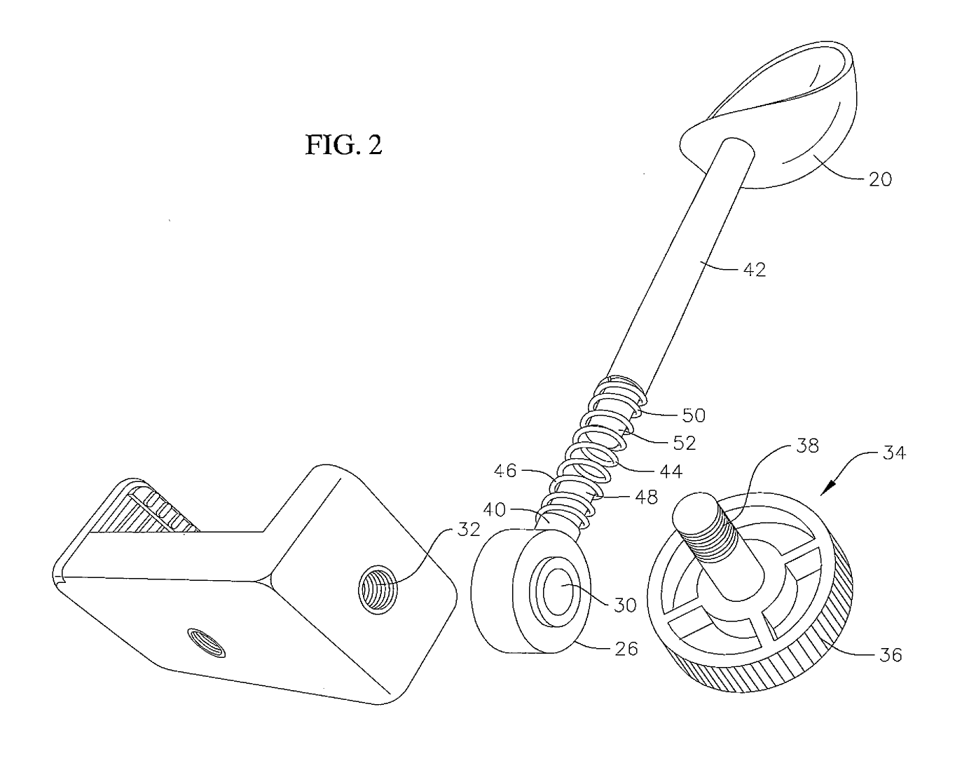

A holding member or holder 20 for holding a treat for the pet is provided in an example embodiment. In the shown example embodiment, the holding member is connected to a side member, as for example side member 16, shown in FIG. 1. A “treat” as used herein refers to a food treat, a toy treat, or any other type of object that attracts a pet's attention. In an example embodiment, the holding member 20 includes an arm 22 and a holder 24. The arm is connected to the grip at one portion thereof and the holder extends from another portion of the arm. In the shown example embodiment, the arm 22 is connected to the grip proximate a first end 26 thereof and the holder extends from an opposite second end 28 of the arm. In an example embodiment, the holder is a receptacle or a cup like structure or a structure that defines a depression for receiving a treat. In an example embodiment, the arm includes an opening 30 proximate the first end thereof as shown in FIG. 2.

The grip in this example embodiment includes a threaded opening 32. A fastener 34 is used to penetrate the opening 30 of the arm and fasten to the threaded opening 32 on the grip. The fastener 34 in an example embodiment includes a head 36 from which extends a threaded fastening member 38 for threading into the threaded opening 32. The head in the shown example embodiment has the shape of a dial that allows for threading of the fastening member to the threaded opening on the grip by turning the head using one's finger(s). This allows for easy fastening of the fastener to the grip using one's finger(s) to lock the arm, and thus the holding member, in position. The arm and holding member may be locked in multiple orientations relative to the grip. Once the arm is oriented in the desired orientation, it may be locked in place by screwing the fastening member to the grip to lock the arm in the desired orientation.

In another example embodiment (not shown) a threaded member may extend from the grip such that it can penetrate the opening 30 of the arm and a nut is then threaded on the threaded member to lock the arm in position.

In the shown example embodiment, the arm is two-section arm. A first section 40 of the arm includes the opening 30 proximate an end thereof. A second section 42 includes the holder. The two sections are connected in a spaced apart relationship using a spring 44. The spring 44 in an example embodiment is a coil spring. A first end portion 46 of the spring is slid over an end portion 48 of the arm first section and a second end portion 50 of the spring is slid over an end portion 52 of the arm second section. The end portions 50, 52 of the arm sections receiving may have a reduced diameter. In an example embodiment, the spring connects to each end portion of each arm section by friction. In the shown example embodiment, the first section 40 of the arm is much shorter than the second section 42 of the arm. The arm second section can flex relative to the arm first section about the spring. In this regard, the arm second section can be pulled and flexed relative to the first second and any treat in the holding member may be launched by releasing the flexed arm second section. In an example embodiment, as shown in FIG. 1, because the holding member 20 is at the end of the arm second section distal from the spring, by making the arm second section longer than the arm first section, more momentum is provided to the holding member when the arm second section is flexed relative to the arm first section for launching a treat.

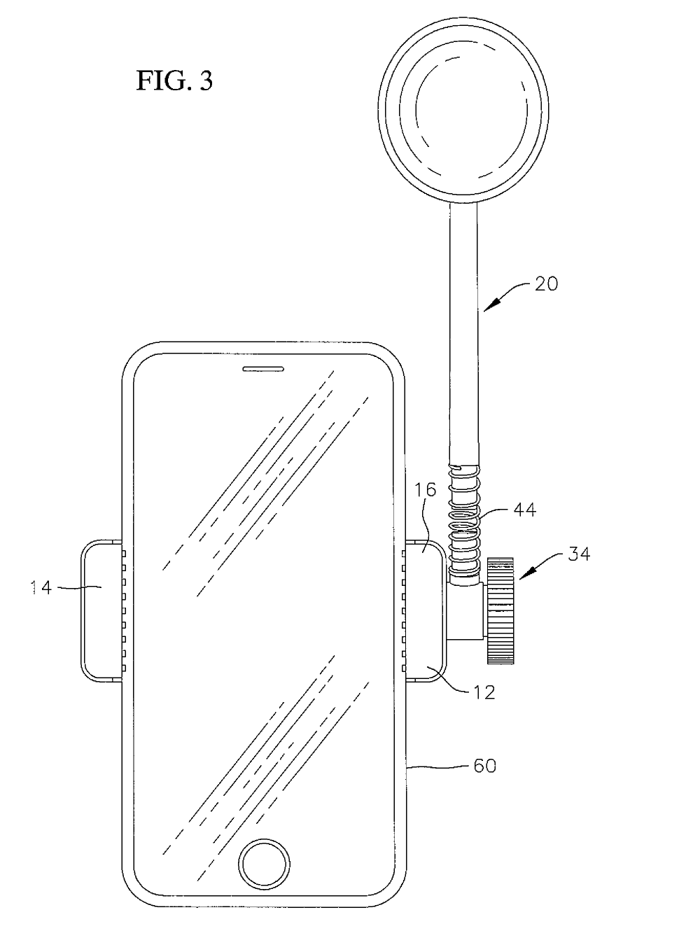

In an example embodiment, a mobile phone 60 is positioned so that it is gripped by the grip 12 as for example shown in FIG. 3. A treat is placed into the holder 20. The holder may be oriented relative to the grip in an appropriate direction so as to position the camera of the mobile phone at the appropriate angle for taking a picture of the pet. As the pet sees the treat is stays focused on the treat allowing one to take its picture using the gripped mobile phone. After the picture of the pet is taken, the holding member may be flexed back by flexing back the second section 41 of the holding member and the spring force causes the treat in the holder to be launched by releasing the second section of the holding member. Your pet then can chase and eat the treat or even bring it back, allowing a repeat of the process and the taking of another picture of the pet. The pet will see this as a game and every time a treat is place in the holder the pet will come to the holder allowing the taking of another picture of the pet.

While the present disclosure has been described with respect to a limited number of embodiments, those skilled in the art, having benefit of this disclosure, will appreciate that other embodiments and modifications can be devised which do not materially depart from the scope of the invention as disclosed herein. All such embodiments and modifications are intended to be included within the scope of this disclosure as defined in the following claims.

What is claimed is:

1. A mobile phone device comprising:
a body for connecting with a mobile phone or camera;
an arm coupled to the body at, or proximate, a proximal end of the arm; and
a recess extending from the arm at or proximate a distal end of the arm.

2. The device as recited in claim 1, wherein the arm is lockeable to the body at only of or plurality of orientations relative to the body.

3. The device as recited in claim 2, further comprising a fastener for locking the arm to the body at said any of the plurality of orientations.

4. The device as recited in claim 1, wherein the arm comprises a first member for being locked relative to the body at said any of the plurality of orientations relative to the body, a second member separate from the first member, and a spring coupling the first member to the second member.

5. The device as recited in claim 4, wherein the recess extends from the second member.

6. The device as recited in claim 5, wherein the recess is a cup.

7. The device as recited in claim 1, wherein the body is clamped to the mobile phone or camera.

8. A mobile phone device comprising:
a body for clamping on to a mobile phone;
an arm comprising a first member coupled to the body and second member separate from the first member;
a spring coupling the first member to the second member; and
a receptacle on the second member for holding an item.

9. The device as recited in claim 8, wherein the second member flexes relative to the first member.

10. The device as recited in claim 8, wherein the arm is lockable to the body at any of a plurality of orientations.

11. The device as recited in claim 10, further comprising a fastener for locking the arm to the body at said any of the plurality of orientations.

12. A method of taking a picture of a pet comprising:
connecting a mobile phone having a camera, or a camera, to a device comprising a flexing arm;
holding a treat with the arm for attracting the pet;
taking a picture of the pet;
flexing the arm; and
releasing the flexed arm launching the treat.

13. The method as recited in claim 12, wherein the device comprises a body and wherein the arm is connected to the body, the method further comprising:
orienting the arm to a desired orientation relative to the body; and
locking the arm at said orientation relative to the body.

14. The method as recited in claim 13, wherein the body is a grip, and wherein connecting comprises gripping said mobile phone having a camera, or said camera, with said grip.

15. The method as recited in claim 12 wherein the arm comprises a first member coupled to a second member via a spring, and wherein locking the arm comprises locking the first member relative to the body.

16. The method as recited in claim 15, wherein the second member comprises a recess, and wherein holding the treat comprises placing the treat in said recess.
